(19) United States
(12) Patent Application Publication
(10) Pub. No.: US 2014/0116048 A1
(43) Pub. Date: May 1, 2014

(54) Multi-Functional Solar Combined Heat and Power System

(71) Applicant: Institute of Nuclear Energy Research, Atomic Energy Council, Executive Yuan R.O. C., (US)

(72) Inventors: Heng-Yi Li, New Taipei City (TW); Chien-Hsiung Lee, Taoyuan County (TW)

(73) Assignee: Institute of Nuclear Energy Research, Atomic Energy Council, Executive Yuan, R.O.C., Taoyuan County (TW)

(21) Appl. No.: 13/872,380

(22) Filed: Apr. 29, 2013

(30) Foreign Application Priority Data
Oct. 29, 2012 (TW) 101140009

(51) Int. Cl. F03G 6/06

(52) U.S. Cl. CPC F03G 6/067
USPC 60/641.15

(57) ABSTRACT

A solar combined heat and power system is provided. The system is multi-functional. Saturated steam and organic vapor are provided to steam and organic Rankine cycle power generators by concentrating solar radiation to solar power thermal energy storage container. Thermoelectric generator chips and solar cells are run at an optimum temperature for generating extra power. A hot water storage tank is used to generate hot water by absorbing latent heat on condense process or by absorbing surplus heat from water or organic fluid when power generators stop. Thus, the present invention improves solar energy usage effectiveness, and provides heat and power with high efficiency.

### TECHNICAL FIELD OF THE INVENTION

The present invention relates to solar device; more particularly, relates to generating high-pressure saturated steam and saturated organic vapor by concentrating solar radiation to solar power thermal energy storage container for running a steam Rankine cycle power generator and an organic Rankine cycle power generator, respectively; with the high-pressure saturated steam and the saturated organic vapor, maintaining the optimum operation temperature of thermoelectric generator chips and solar cells for generating extra power; with a hot water storage tank body, not only absorbing latent heat generated on the condense process for generating hot water but also, when the steam and organic Rankine cycle power generators stop working, absorbing surplus heat through organic fluid or water to generate hot water by thermosyphon circulation; and hence, improving the solar energy usage effectiveness, providing power and heat with high efficiency.

### DESCRIPTION OF THE RELATED ARTS

As more and more fossil fuels, like oil, coal and natural gas, are consumed, high fuel price and economy impacts are unavoidable. Furthermore, emission of the waste gas like carbon dioxide strengthens green house effect and the climate change. Hence, energy exploring and environment protection are both emphasized. Solar energy is a renewable energy resource which has harmless and non-pollutant characteristics. The energy brought by solar radiation in a day is enough for one year consumption of global human life. Therefore, development and application of solar energy and other renewable energy resource is critical for earth sustainability.

Yet, solar energy is less or even none in the cloudy weather and the night time. Hence, extra energy generated during sunny days should be stored for use in times when sunlight is weak or unavailable. However, storage devices like batteries are mostly expensive or low in efficiency.

The followings are prior arts:

(A) A device uses globe-shaped concentrators and optical-line diffusers to concentrate and split solar radiation and generate electric power with a photoelectric module and a thermoelectric generator unit for achieving a best efficiency.

(B) A device uses concentrators to concentrate solar radiation for heating a high boiling point thermal medium in a container. There are heat-exchanging pipes in the container. Water flows in to generate steam for providing a steam Rankine cycle to generate power.

(C) A device absorbs and stores solar energy through collector which has cover contained high-enthalpy material. After absorbing and storing solar energy, the energy is transmitted to a hot-water unit, an absorption chiller, an adsorption chiller, or an ejection chiller.

(D) A device integrates the interactions of a solar panel, a heat collector, a power generator and a thermoelectric cooling chip. Hence, heat loss is reduced and efficiency of power generation is improved.

(E) A device has heating module which heats thermal energy storage unit by solar thermal collector and concentrating lenses. And the heated energy storage unit drives a Stirling engine to generate power.

(F) In U.S. Pat. No. 5,417,052 “Hybrid solar central receiver for combined cycle power plant”, solar radiation is focused on a surface of a central receiver through heliostats to heat molten salt contained within. The heated salt then pre-heats compressed air at gas turbine inlet. The gas turbine drives a power generator and the waste heat of exhaust gases are recycled to generate steam for driving a steam turbine to generate additional power.

(G) In U.S. Pat. No. 7,836,695 B2 “Solar energy system”, air is heated by a solar collection assembly. The heated air passes through a thermal storage assembly and a steam generator. The steam generator generates steam for driving a steam turbine to generate power.

Nevertheless, the prior arts have the following disadvantages:

1. For heating water to generate steam or heating air by thermal medium, the thermal medium needs to circulate through the heat-exchanging device; or, the water or air needs to circulate through heat exchangers.

2. The utilizations of solar energy are not diverse so that much energy is lost and energy efficiency is low.

3. The operational temperatures of the solar cells and the thermoelectric generator chips are not well controlled so that they are not operated to achieve the optimum efficiency or components are damaged owing to overheating.

4. The hot-water loop needs to be driven by a circulation pump so that energy loss is increased and generation efficiency is decreased.

Hence, the prior arts do not fulfill all users' requests on actual use.

### SUMMARY OF THE INVENTION

The main purpose of the present invention is to generate high-pressure saturated steam and saturated organic vapor by concentrating solar radiation to solar power thermal energy storage container for running a steam Rankine cycle power generator and an organic Rankine cycle power generator, respectively; with the high-pressure saturated steam and the saturated organic vapor, to maintain solar cells and thermoelectric generator chips to be run at a optimum temperature for generating extra power; with a hot water storage tank body, not only to absorb latent heat generated on the condense process for generating hot water but also, when the steam and organic Rankine cycle generators stop working, to absorb surplus heat through an organic fluid or water to obtain hot water through thermosyphon circulation; and, thus, to improve solar energy usage effectiveness, and provide power and heat with high efficient.

To achieve the above purpose, the present invention is a multi-functional solar combined heat and power system, comprising a plurality of heliostat-dish solar concentrators, a solar power thermal energy storage container, a steam Rankine cycle power generator, an organic Rankine cycle power generator and a hot water storage tank, where the container is located in the center of the clustered concentrators so that the concentrators surround around; the container comprises a container body and a supporting frame at bottom of the container body; the steam Rankine cycle power generator is connected with the container; the organic Rankine cycle power generator is connected with the container; and the hot water storage tank is connected with the steam Rankine cycle power generator and the organic Rankine cycle power generator. Accordingly, a novel multi-functional solar combined heat and power system is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the schematic view showing the preferred embodiment according to the present invention;

FIG. 2 is the vertical sectional view showing the thermal energy storage container body;

FIG. 3 is the horizontal view showing the A-A′ section of the thermal energy storage container body; and

FIG. 4 is the horizontal view showing the B-B′ section of the thermal energy storage container body.

### DESCRIPTION OF THE PREFERRED EMBODIMENT

The following description of the preferred embodiment is provided to understand the features and the structures of the present invention.

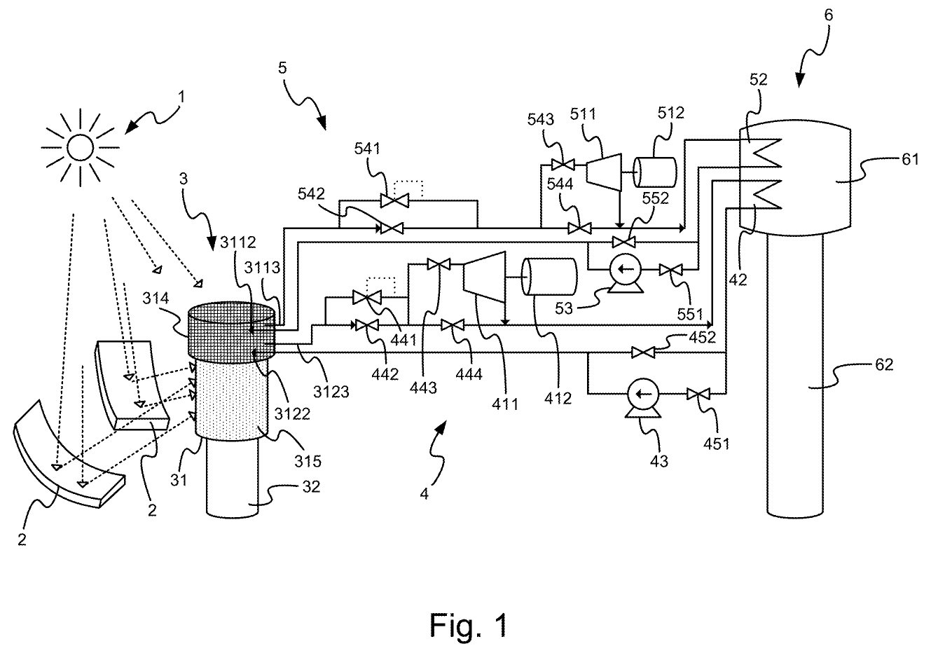

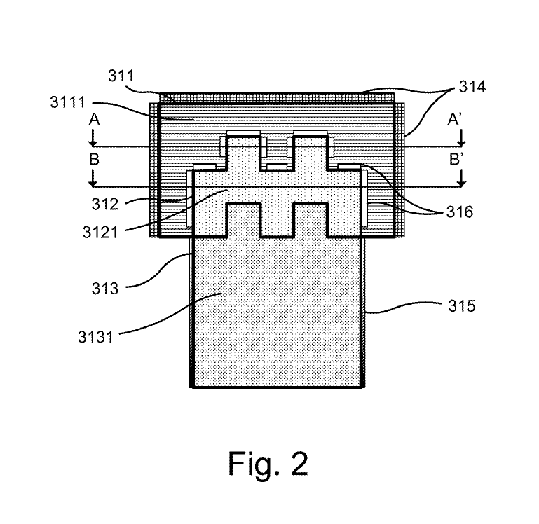

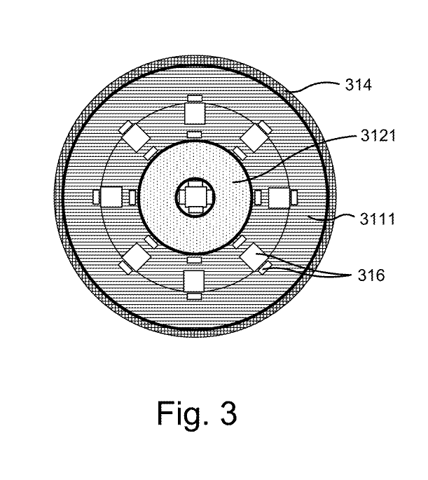

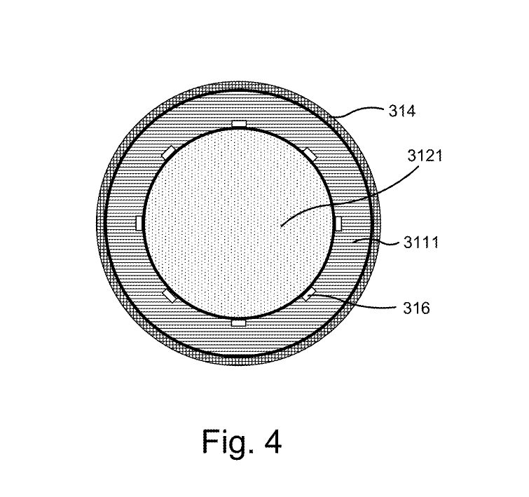

Please refer to FIG. 1 to FIG. 4, which are a schematic view showing the preferred embodiment according to the present invention; a vertical sectional view showing the thermal energy storage container body; and horizontal views showing an A-A′ and a B-B′ sections of the thermal energy storage container body. As shown in the figures, the present invention is a multi-functional solar combined heat and power system, comprising a heliostat-dish solar concentrator 2, a solar power thermal energy storage container 3, a steam Rankine cycle power generator 4, an organic Rankine cycle power generator 5 and a hot water storage tank 6.

The heliostat-dish solar concentrator 2 comprises a plurality of reflectors to effectively concentrating solar radiation 1 to the surface of a solar power thermal energy storage container body 31.

The solar power thermal energy storage container 3 is set in the center of the clustered heliostat-dish solar concentrators 2 so that the concentrators 2 surround the container 3. The container 3 comprises the solar power thermal energy storage container body 31; and a container supporting frame 32 at bottom of the solar power thermal energy storage container body 31. The solar power thermal energy storage container body 31 has an upper portion and a lower portion on the surface. The upper portion is covered with solar cells 314. The lower portion is coated with a selective heat-absorption film 315. The container body 31 has chambers inside and the chambers comprise an organic-fluid chamber 311, a steam chamber 312 and a high-enthalpy chamber 313. For increasing a heat-transferring area in between, interfaces between the chambers are not flat but with special designed shape. Solar radiation 1 is concentrated on the selective heat-absorption film 315 through the heliostat-dish solar concentrator 2. The selective heat-absorption film 315 covers the high-enthalpy chamber 313. The selective heat-absorption film 315 transfers absorbed solar radiation heat to high-enthalpy medium 3131, like a nitrate, a nitrite, a phosphate, a sulphate, chloroflo or a high-temperature-resistant oil, loaded in the high-enthalpy chamber 313. Besides, the solar cells 314 are mounted on surface of the upper portion of the solar power thermal energy storage container body 31 to transform solar energy into electric energy through photovoltaic effect. The solar cells 314 cover the organic-fluid chamber 311. The organic-fluid chamber 311 is filled with an organic fluid 3111 like refrigerant, benzene, alkane, carbon dioxide (CO₂) or ammonia (NH₃). The organic fluid 3111 is boiled through absorbing the accumulated heat from the solar cells 314 and transforming the organic fluid 3111 from liquid state into a saturated vapor state for maintaining the solar cells 314 to be run at an optimum operational temperature. In the solar power thermal energy storage container body 31, the steam chamber 312 is located between the high-enthalpy chamber 313 and the organic-fluid chamber 311, where the steam chamber 312 is filled with water and the water is heated to a high-pressure saturated steam 3121 by the high-enthalpy medium 3131. Thermoelectric generator chips 316 are mounted between the organic-fluid chamber 311 and the steam chamber 312. Hot ends and cold ends of the thermoelectric generator chips 316 are connected with the steam chamber 312 and the organic-fluid chamber 311, respectively. Electric energy is generated by the temperature difference between the hot end and the cold end through Seebeck effect. Furthermore, the optimum operational temperature of the hot is maintained end by the high-pressure saturated steam 3121. The organic-fluid chamber 311 has an organic-fluid chamber inlet 3112 and an organic-fluid chamber outlet 3113 connected with an outlet and an inlet of the organic Rankine cycle power generator 5, respectively. The steam chamber 312 has a steam chamber inlet 3122 and a steam chamber outlet 3123 connected with an outlet and an inlet of the steam Rankine cycle power generator 4, respectively.

The steam Rankine cycle generator 4 comprises a steam expansion turbine 411, a first power generator 412, a first heat-exchanging pipe 42, a condense water circulation pump 43, a steam pressure regulating valve 441, a first steam control valve 442, a second steam control valve 443, a third steam control valve, a first condense control valve 451 and a second condense control valve 452.

When there are enough thermal energy and steam pressure, a steam Rankine cycle is used for generating power. Therein, the first steam control valve 442, the third steam control valve 444 and the second condense control valve 452 are closed; the second steam control valve 443 and the first condense control valve 451 are opened; the high-pressure saturated steam 3121 leaves from the vapor chamber outlet 3123; pressure is stabilized through the vapor pressure regulating valve 441; the high pressure steam 3121 expands through the steam expansion turbine 411 to generate power by the first power generator 412 and become low pressure steam; and, after the low pressure steam 3121 flows through the first heat-exchanging pipe 42 where it releases heat and is condensed to water, the water is then pressurized by the condense water circulation pump 43 to go back to the steam chamber 312 through the vapor chamber inlet 3122.

When there are not enough heat energy and steam pressure, a thermosyphon cycle is used for recycling heat. Therein, the first steam control valve 442, the third steam control valve 444 and the second condense control valve 452 are opened; the second steam control valve 443 and the first condense control valve 451 are closed; and, after hot water or low-pressure steam flows through the first heat-exchanging pipe 42 to release heat through thermosyphon effect, the condensed water flows back to the vapor chamber 312 through the steam chamber inlet 3122;

The organic Rankine cycle generator 5 comprises an organic-vapor expansion turbine 511, a second power generator 512, a second heat-exchanging pipe 52, an organic-fluid circulation pump 53, an organic-vapor pressure-regulating valve 541, a first organic-vapor control valve 542, a second organic-vapor control valve 543, a third organic-vapor control valve 544, a first organic-liquid control valve 551 and a second organic-liquid control valve 522.

When there are enough heat energy and organic vapor pressure, an organic Rankine cycle is used for generating power. Therein, the first organic-vapor control valve 542, the third organic-vapor control valve 544 and the second organic-liquid control valve 552 are closed; the second organic-vapor control valve 543 and the first organic-liquid control valve 551 are opened; the saturated organic vapor 3111 leaves from the organic-fluid chamber outlet 3113; pressure is stabilized through the organic-vapor pressure-regulating valve 541; the high pressure organic vapor 3111 expands through the organic-vapor expansion turbine 511 to generate power by the second power generator 512 and become low pressure organic-vapor; the low pressure organic vapor 3111 then passes through the second heat-exchanging pipe 52 where it releases heat and is condensed to organic-liquid; and, the organic-liquid is then pressurized by the organic-liquid circulation pump 53 to go back to the organic-fluid chamber 311 through the organic-fluid chamber inlet 3112.

When there are not enough heat energy and organic-vapor pressure, a thermosyphon cycle is used for recycling heat. Therein, the first organic-vapor control valve 542, the third organic-vapor control valve 544 and the second organic-liquid control valve 552 are opened; the second organic-vapor control valve 543 and the first organic-liquid control valve 551 are closed; and, after the organic liquid or low-pressure organic vapor passes through the second heat-exchanging pipe 52 to release heat through thermosyphon effect, the condensed liquid goes back to the organic-fluid chamber 311 through the organic-fluid chamber inlet 3112.

The hot water storage tank 6 comprises a hot water storage tank body 61; and a tank supporting frame 62 at bottom of the hot water storage tank body 61. The hot water storage tank body 61 is positioned at a height higher than a top of the solar power thermal energy storage container body 31. When the steam Rankine cycle power generator 4 and the organic Rankine cycle power generator 5 are at work, the hot water storage water tank body 61 is used as a cooling device to absorb and store latent heat generated on condensing the steam or organic vapor. When the steam Rankine cycle power generator 4 and the organic Rankine cycle power generator 5 stop working, the steam or organic vapor directly transfers heat of the solar power thermal energy storage container body 31 to the hot water storage tank body 61 through thermosyphon effect for obtaining hot water without a circulation pump.

Thus, the present invention has the following advantages:

A) The heliostat-dish solar concentrator 2 concentrates solar radiation 1 on the upper portion surface of the solar power thermal energy storage container body 31 to directly transform solar energy into electric energy by the solar cells 314 through photovoltaic effect. In addition, the organic fluid is boiled to generate saturated organic vapor for maintaining the solar cells 314 to be run at an optimum temperature.

B) The hot ends and the cold ends of the thermoelectric generator chips 316 are connected with the steam chamber 312 and the organic-fluid chamber 311, respectively, for generating power by the temperature difference between the hot and cold ends through Seebeck effect. Besides, the hot end is maintained to be run at a optimum temperature by the high-pressure saturated steam.

C) The high-enthalpy medium 3131 of the high-enthalpy chamber 313 absorbs solar energy and transfers thermal energy to the steam chamber 312 for boiling water to generate high-pressure saturated steam provided for running the steam Rankine cycle generator 4. After being condensed to water through the hot water storage tank 6, the condensed water then goes back to the steam chamber 312 for boiling again. Furthermore, the boiling water or saturated steam not only heat the thermoelectric generator chips 316 for generating power but also transfers heat to the organic-fluid chamber 311 for boiling the organic liquid to the saturated organic vapor driving the organic Rankine cycle power generator 5.

D) The hot water storage tank 6 is used as a cooling device on running the steam Rankine cycle power generator 4 and the organic Rankine cycle power generator 5 for obtaining hot water by absorbing and storing latent heat generated during the condense process. When the steam Rankine cycle generator 4 and the organic Rankine cycle generator 5 stop working, the steam or organic vapor directly transfers heat of the solar power thermal energy storage container body 31 to the hot water storage water tank body 61 through thermosyphon effect for obtaining hot water without driven by a circulation pump.

To sum up, the present invention is a multi-functional solar combined heat and power system, where high-pressure saturated steam and saturated organic vapor are generated by concentrating solar radiation to solar power thermal energy storage container for running a steam Rankine cycle power generator and an organic Rankine cycle power generator, respectively; the saturated organic vapor and the high-pressure saturated steam maintain solar cells and thermoelectric generator chips to be run at a optimum temperature for generating extra power; a water tank body not only absorbs latent heat generated on a condense process for obtaining hot water but also, when the steam and organic Rankine cycle power generators stop working, the steam or organic vapor directly transfers heat of the solar power thermal energy storage container body 31 to the hot water storage tank body 61 through thermosyphon effect for obtaining hot water without a circulation pump; and, thus, the present invention improves efficiency on using solar energy, generating power and providing heat source.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A multi-functional solar combined heat and power system, comprising
a plurality of heliostat-dish solar concentrators, said concentrators;
a solar power thermal energy storage container, said container being located in the center of the clustered said concentrators so that said concentrators surround said container, said container comprising
a container body; and
a container supporting frame located at bottom of said container body;
a steam Rankine cycle power generator, said steam cycle being connected with said container;
an organic Rankine cycle generator, said organic cycle being connected with said container; and
a hot water storage tank, said water tank being connected with said steam cycle and said organic cycle.

2. The apparatus according to claim 1,
wherein said container body has two portions on the surface of said container body and said two portions comprises an upper portion and a lower portion;
wherein said upper portion is covered solar cells and said lower portion is coated with selective heat-absorption film;
wherein selective heat-absorption film said film has high-enthalpy chamber inside; and
wherein said high-enthalpy chamber is loaded with a high-enthalpy medium.

3. The apparatus according to claim 2,
wherein said container body has chambers inside and said chambers comprises an organic-fluid chamber, a steam chamber and said high-enthalpy chamber; and
wherein said steam chamber is located between said high-enthalpy chamber and said organic-fluid chamber.

4. The apparatus according to claim 3,
wherein inter-surfaces between said organic-fluid chamber, said vapor chamber and said high-enthalpy chamber are not flat surfaces but with special designed shape.

5. The apparatus according to claim 3,
wherein said organic-fluid chamber is loaded with an organic fluid.

6. The apparatus according to claim 5,
wherein said organic fluid is selected from a group consisting of a refrigerant, a benzene, an alkane, carbon dioxide (CO₂) and ammonia (NH₃).

7. The apparatus according to claim 3,
wherein thermoelectric generator chips are located between said organic-fluid chamber and said steam chamber;
wherein hot ends of said thermoelectric chips are connected with said steam chamber and cold ends of said thermoelectric generator chips are located in said organic-fluid chamber and power is generated by the temperature difference between said hot ends and said cold ends of said thermoelectric chips through Seebeck effect; and
wherein a preferred operation temperature of said hot end is kept by a high-pressure saturated steam.

8. The apparatus according to claim 3,
wherein said organic-fluid chamber has an organic-fluid chamber inlet and an organic-fluid chamber outlet to be connected with said organic Rankine cycle power generator, separately.

9. The apparatus according to claim 3,
wherein said steam chamber has a steam chamber inlet and a steam chamber outlet to be connected with said steam Rankine cycle power generator, separately.

10. The apparatus according to claim 2,
wherein said high-enthalpy medium is selected from a group consisting of a nitrate, a nitrite, a phosphate, a sulphate, chloroflo and a high-temperature-resistant oil.

11. The apparatus according to claim 1,
wherein said steam Rankine cycle generator comprises
a steam expansion turbine;
a first power generator;
a first heat-exchanging pipe;
a condense water circulation pump;
a steam pressure regulating valve;
a first steam control valve;
a second steam control valve;
a third steam control valve;
a first condense control valve; and
a second condense control valve.

12. The apparatus according to claim 1,
wherein said organic Rankine cycle generator comprises
an organic-vapor expansion turbine;
a second power generator;
a second heat-exchanging pipe;
an organic-liquid circulation pump;
an organic-vapor pressure-regulating valve;
a first organic-vapor control valve;
a second organic-vapor control valve;
a third organic-vapor control valve;
a first organic-liquid control valve; and
a second organic-liquid control valve.

13. The apparatus according to claim 1,
wherein said hot water storage tank comprises a water tank body; and a tank supporting frame located at bottom of said water tank body;
wherein said water tank body is positioned at a height higher than a top of said container body; and
wherein water absorbs heat from said container directly through thermosyphon effect without a circulation pump as said steam cycle and said organic cycle stop.
